(19) United States
(12) Patent Application Publication
(10) Pub. No.: US 2008/0167116 A1
(43) Pub. Date: Jul. 10, 2008

(54) Slot Machine Bonus Round With Color Picking Game

(76) Inventor: Ignacio Gerson, Buenos Aires (AR)

Correspondence Address: MUSKIN & CUSICK LLC, 30 Vine Street, SUITE 6, Lansdale, PA, 19446, US

(21) Appl. No.: 11/928,413

(22) Filed: Oct. 30, 2007

Related U.S. Application Data
(60) Provisional application No. 60/865,193, filed on Nov. 10, 2006.

(51) Int. Cl. A63F 13/00

(52) U.S. Cl. 463/22

(57) ABSTRACT

A slot machine method, apparatus, and computer readable storage to implement a color (or other attribute) guessing game, wherein a player can guess colors associated with each a plurality of elements (e.g., doors, boxes, etc.) After each guess, the player is then presented with the individual colors that the player guessed correctly, and the player can guess again. The player will continue to guess until the player has correctly identified each element's respective attribute. The player is then given a monetary award based on a number of guesses that the player took to guess all of the elements correctly.

### CROSS REFERENCE TO RELATED APPLICATIONS

This Application claims benefit of provisional application 60/865,193, filed Nov. 10, 2006, which is incorporated by reference herein in its entirety.

This Application is also related to the following ten applications identified by their application number, all nine applications are incorporated by reference herein in their entireties: Ser. No. 11/035,691 (“Slot Machine Game that Allows Player to Purchase Reel Respins”); Ser. No. 11/326,125 (“Slot Machine Bonus Game); Ser. No. 11/337,960 (“Slot Machine with Skill Aspect”); Ser. No. 11/558,405 (“System and Method for Allowing Piggyback Wagering”); Ser. No. 11/609,315 (“System and Method for Allowing Piggyback Wagering”); Ser. No. 11/459,253 (“Slot Machine Bonus Game”); Ser. No. 11/558,564 (“System and Method for Administering a Progressive Jackpot Limited to a Bonus Round”); Ser. No. 11/678,050 (“Slot Machine Game With Additional Features”); Ser. No. 11/764,689 (“Slot Machine Game with Additional Award Indicator”); and Ser. No. 11/776,508 (“Slot Machine Game With User Selectable Themes”). All ten of these applications are incorporated by reference herein in their entireties for all purposes. Any and all features of any of these applications can be combined with each other and with any feature(s) described herein.

### BACKGROUND OF THE INVENTION

1. Field of the Invention

The present inventive concept relates to a system, method, and computer readable storage, for providing additional themes to slot machine games.

2. Description of the Related Art

Slot machine games are a billion dollar industry. The current three or five reel machines have been around for a long time and some players may find current game play monotonous.

What is needed is a slot machine with additional slot machine features which will generate more excitement for players and/or more revenue as well.

### SUMMARY OF THE INVENTION

It is an aspect of the present general inventive concept to provide additional features to slot machine games.

The above aspects can also be obtained by a method that includes (a) displaying at least two first elements; (b) displaying at least two second elements, a number of second elements being equal to a number of first elements; (c) determining randomly at least two preselected associations between each of the first elements and the second elements; a number of preselected associations being equal to the number of first elements; (d) allowing a player to input at least two guessed associations; (e) identifying correctly guessed associations which comprise each of the guessed associations that matches preselected associations; (f) outputting to the player the correctly guessed associations; (g) permitting the player to continue the allowing, identifying, and outputting, until the identifying identifies that all guessed associations match all preselected associations, upon which the bonus round is completed; and (h) awarding an award based on a number of guesses required by the player until the bonus round is completed

The above aspects can also be obtained by an apparatus that includes (a) a processing unit to perform: (b) displaying at least two first elements; (c) displaying at least two second elements, a number of second elements being equal to a number of first elements; (d) determining randomly at least two preselected associations between each of the first elements and the second elements; a number of preselected associations being equal to the number of first elements; (e) allowing a player to input at least two guessed associations; (f) identifying correctly guessed associations which comprise each of the guessed associations that matches preselected associations; (g) outputting to the player the correctly guessed associations; (h) permitting the player to continue the allowing, identifying, and outputting, until the identifying identifies that all guessed associations match all preselected associations, upon which the bonus round is completed; (i) awarding an award based on a number of guesses required by the player until the bonus round is completed; and (j) an output device to output results of the processing unit.

The above aspects can also be obtained by an apparatus that includes (a) displaying at least two mechanical slot reels, each reel comprising a plurality of symbols; (b) determining at least two random symbols for each reel, each random symbol corresponding to each of the at least two slot reels; (c) allowing a player to rotate each of the at least two mechanical slot reels to display a guessed symbol on each reel, the guessed symbol selected by the player; (d) identifying which guessed symbols match corresponding random symbols; (e) permitting the player to repeat the allowing and identifying until all guessed symbols match corresponding random symbols; and (f) awarding an award to the player based on a number of times the allowing is performed.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1A illustrates an exemplary output of a first stage of a bonus round, according to an embodiment;

FIG. 1B illustrates an exemplary output of a second stage of a bonus round, according to an embodiment.

FIG. 2A illustrates an exemplary output of a second stage of a bonus round, according to an embodiment;

FIG. 2B illustrates an exemplary output of a fourth stage of a bonus round, according to an embodiment;

FIG. 3A illustrates an exemplary output of a fifth stage of a bonus round, according to an embodiment;

FIG. 3B illustrates an exemplary output of a sixth stage of a bonus round, according to an embodiment;

FIG. 4A illustrates an exemplary output of a seventh stage of a bonus round, according to an embodiment.

FIG. 4B illustrates an exemplary output of an eighth stage of a bonus round, according to an embodiment;

FIG. 5 is an exemplary flowchart of a method to implement a bonus round, according to an embodiment;

FIG. 6 is an exemplary block diagram of exemplary hardware that can be used to implement methods described herein, according to an embodiment; and

FIG. 7 is a drawing of a guessing game using mechanical slot reels, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Embodiments of the invention relate to slot machine games, where a player typically places a wager, presses a button to spin the reels, the reels each stop at a random position. Payouts are then determined by comparing all paylines played to a predetermined set of winning combinations, and then the determined payouts, if any, are awarded to the player based on the wager. Additional features can augment the excitement of a player and may also result in increased action for the casino.

A slot machine bonus round (triggered by a triggering condition such as getting a predetermined combination on the reels on the initial spin) will allow a player to play a color (or other indicia) picking game can be presented to the player as a bonus round.

A player can be presented with a plurality of doors (e.g., 5) and behind each door is a colored object (e.g., a ball), each colored object being of a different color. The goal is for the player to guess which color is behind each door. The colored balls behind each door can be determined randomly. For example, five doors can be presented: 1 2 3 4 5. And five colors: red, orange, green, blue, indigo. In this example, the computer has selected door 1=red, door 2=indigo, door 3=blue, door 4=green, and door 5=orange, but this information is not displayed to the player.

The player can touch each color and then touch a door in order to guess which color goes with which door. If the player guesses right on the first try, the player can win a highest award (or award chosen by a formula that has the highest expected value).

If the player gets some correct, the ones the player got right can be locked into place and the player can have another guess. For example, in the above example, if the player guesses door 1=red, door 2=orange, door 3=green, door 4=blue, and door 5=indigo, then the player has gotten door 1 correct but the other doors incorrect. Thus, the player can be offered another guess, while the red ball is locked on the first door (in other words, the player got door 1 correct and so now the player does not need to guess for door 1 again and the player also knows the other doors cannot be red)

The player now makes the following guess: door 2=blue, door 3=green, door 4=indigo, door 5=orange. The slot machine determines (by comparing the guesses with the randomly determines order) that the player has guessed correctly for door 5. Thus, door 5 now reflects the orange color as the correct guess, and the player now guesses a third time: door 2=blue, door 3=indigo, door 4=green. Of course, the player has guessed foolishly here because the player had already guessed blue for door 2 which was indicated to be incorrect.

The slot machine determines that the player has guessed correctly for door 4, which is reflected in the display.

The player now makes a fourth guess and guesses (actually not guesses but deduces) that door 2=indigo and door 3=blue. The player has now solved the puzzle after four guesses. A paytable can be used such as the one that follows in Table I in order to determine the payouts based on a number of guesses it took the player:

TABLE I

| # of guesses | payscale A | payscale B |
|---|---|---|
| 1 | $100 | $80 + RND ($40) |
| 2 | $80 | $53 + RND (30) |
| 3 | $25 | $25 + RND (10) |
| 4 or more | $10 | $RND (15). |

Table I illustrates two payscales, A and B (either can be used, and of course these are merely examples). If the player guesses on the first try, the player can win $100 in payscale A. If payscale B is being used, then the payer wins $80+a random number from (1-40) (e.g., $80+$13=$93).

In a further embodiment, the player can be presented with a hint as to the locations of the colors. One or more (e.g., 2, 3, etc.) colored balls can already be presented by their respective door in order to make the player's task easier. For example, out of the five doors, the slot game can immediately present that door 1=red so that the player really only has to guess four colors/doors instead of five. The player may be presented with the option to take a hint, at the expense of reducing the awards that can be earned when the bonus round is over.

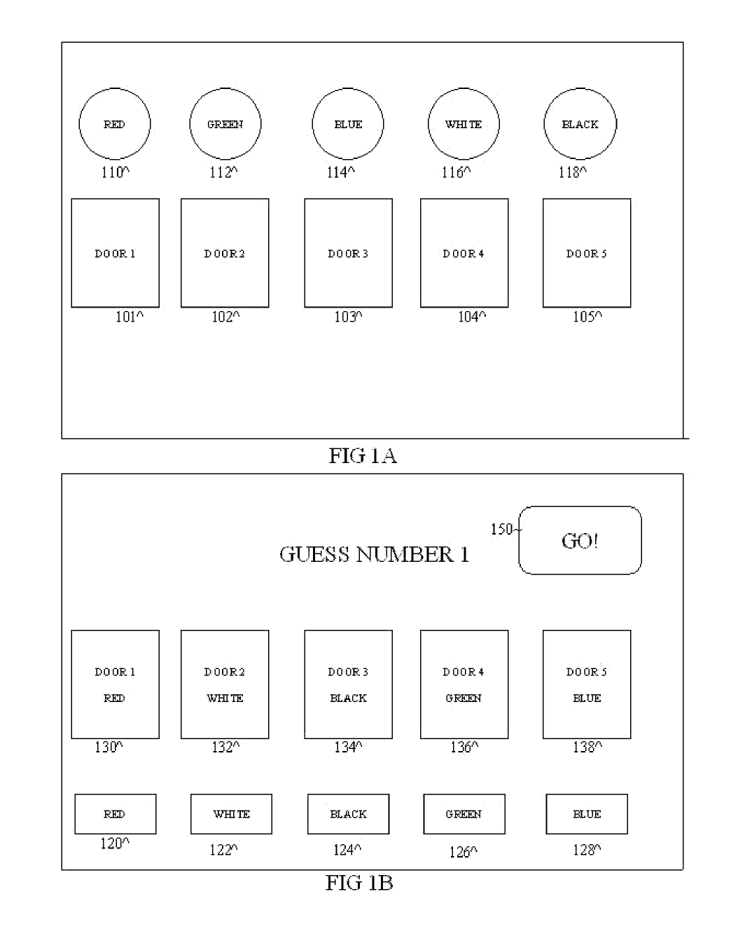

FIG. 1A illustrates an exemplary output of a first stage of a bonus round, according to an embodiment.

Five elements (doors, boxes, icons, can be anything) 101, 102, 103, 104, 105 are displayed. Five attributes that can be assigned to the elements (e.g., colors, shapes, etc.) 110, 112, 114, 116, 118. The attributes are randomly shuffled and one attribute is assigned to each element respectively, although the assignments are not displayed (kept hidden) from the player. For example, a colored ball is hidden behind each door.

FIG. 1B illustrates an exemplary output of a second stage of a bonus round, according to an embodiment. In the second stage, the player makes a guess as to each element's respective hidden attribute.

For example, the first door 130 can be assigned a guess of red by the player first touching the red attribute 110 and then touching the first door 130. In this manner, all five (or however many number of elements are being used) can each be assigned an attribute. Typically, all elements must be assigned (guessed) an attribute before the player can proceed.

A row of attributes (colors) is displayed 120, 122, 124, 126, 128. The player can assign a color to an element by touching an attribute (color) in the row and then touching a particular element (door). In FIG. 1B, the player can make his or her guess by assigning attributes (in this case colors) to elements (in this case doors 130, 132, 134, 136, 138).

The player can press a “go” button 150 when the player is done assigning attributes to elements to indicate that the player's guess is ready. Once the player pressed the “go” button, the bonus round will evaluate the player's guess.

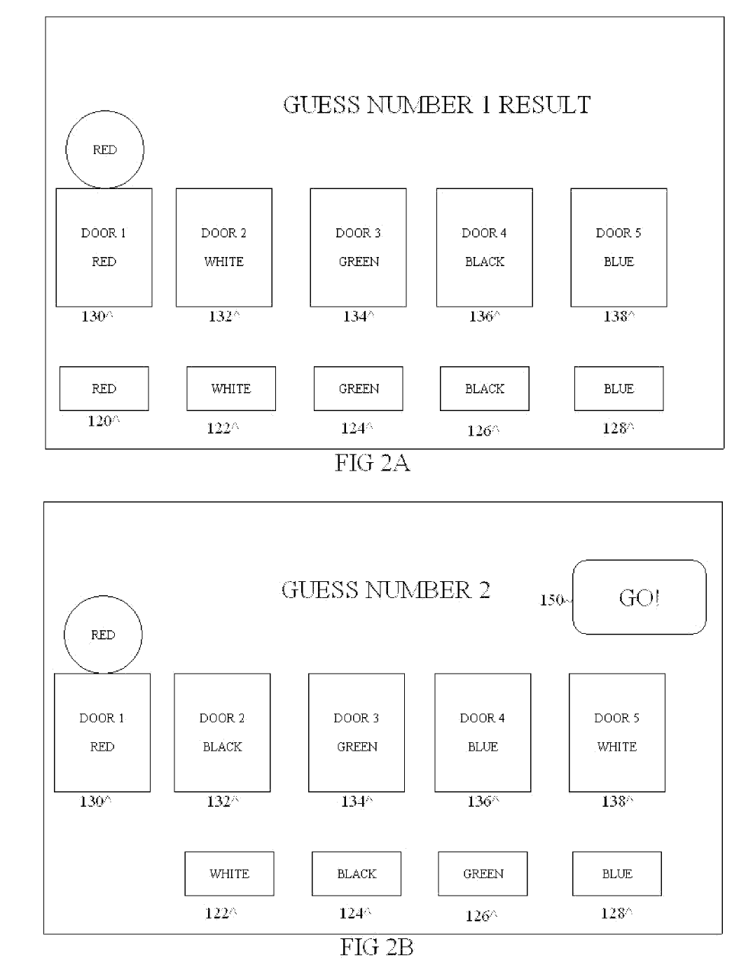

FIG. 2A illustrates an exemplary output of a third stage of a bonus round, according to an embodiment.

In FIG. 2A, the bonus round has evaluated the player's guess (from FIG. 1B), and outputs the evaluation. In this case, the player had guessed the first door 130 correctly (red), while guessing the remaining doors (132, 134, 136, 138) incorrectly.

FIG. 2B illustrates an exemplary output of a fourth stage of a bonus round, according to an embodiment.

In this fourth stage, the player guesses again. The player already knows the first element (door) 130 is correct and that the color red has already been assigned, so the player's task is now to assign the remaining doors 132, 134, 136, 138 to their respective attributes (colors).

The remaining attributes (122, 124, 126, 128) that were not correctly assigned on prior guesses are available to the player to assign to the remaining doors. In this example the player assigned black to the second door 132, green to the third door 134, blue to the fourth door 136, and white to the fifth door 138.

The player can again press the go button 150 once his or her selections are complete so that the bonus round can evaluate the player's selections.

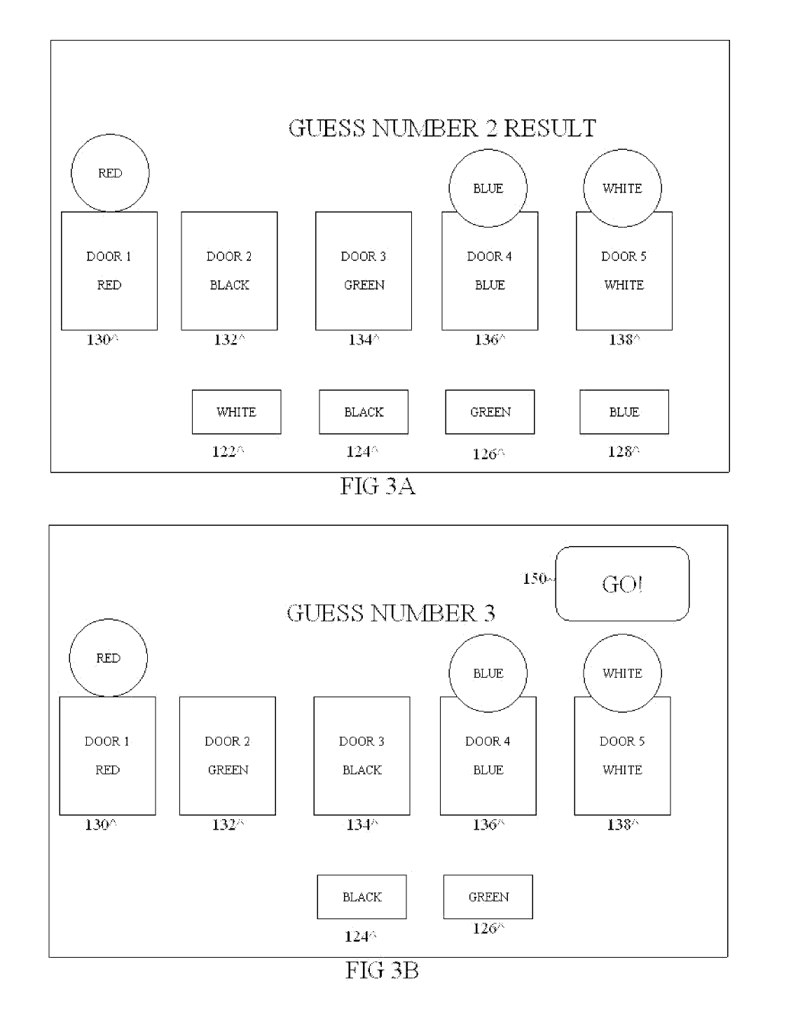

FIG. 3A illustrates an exemplary output of a fifth stage of a bonus round, according to an embodiment.

Based on the player's guess in guess number two (from FIG. 2B), the player has guessed two more doors correctly (door 4 136 and door 5 138). Thus, there are only two remaining doors (132, 134) that have not been correctly assigned. The player should now know which colors to assign these doors (since the correct answer must be the opposite of the player's prior incorrect assignments of these two doors).

FIG. 3B illustrates an exemplary output of a sixth stage of a bonus round, according to an embodiment.

Here the player assigns the two remaining incorrect doors (132, 134) the colors of green, black, respectively.

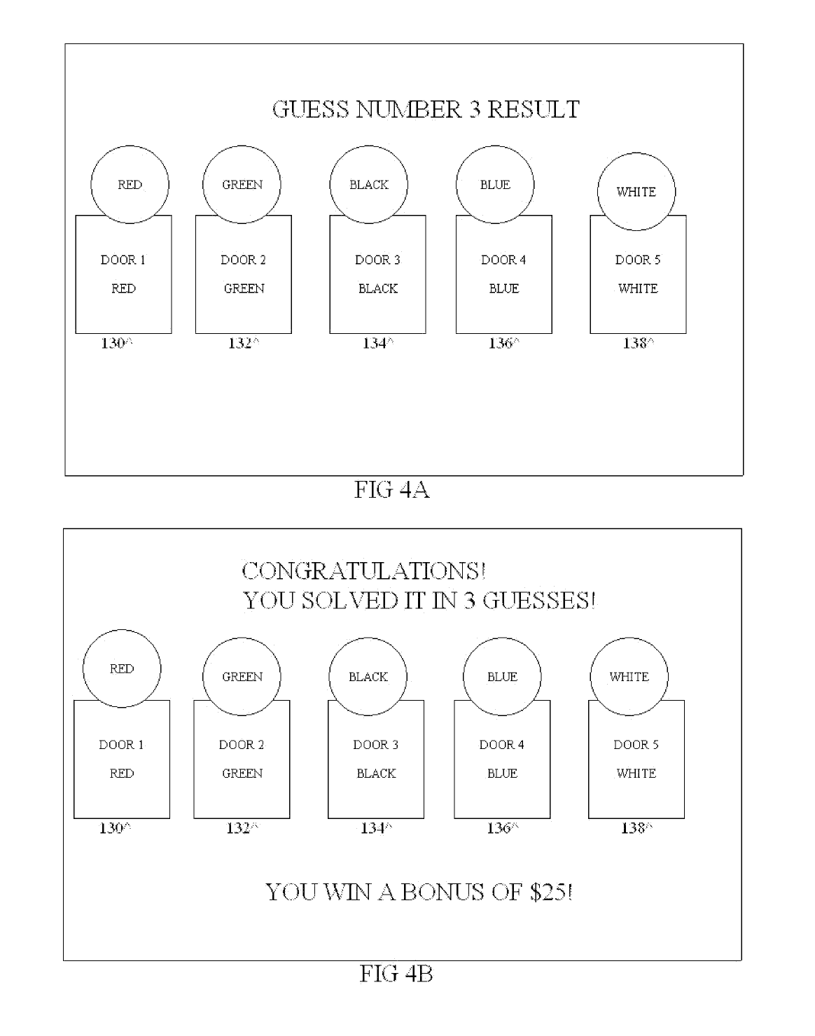

FIG. 4A illustrates an exemplary output of a seventh stage of a bonus round, according to an embodiment.

The result of the prior (third guess) from FIG. 3B is displayed, which shows that all of the doors have been assigned their correct respective attribute (the player guessed correctly in its entirety). Once the player guesses all of the elements correctly, then the bonus round ends and the award can be determined.

FIG. 4B illustrates an exemplary output of an eighth stage of a bonus round, according to an embodiment.

The award is displayed. The $25 award displayed is awarded to the player and is based on a number of guesses that the player took to reach the end of the bonus round. In this case, the player took three guesses. Had the player took two guesses, the award would typically be higher (e.g., $50), and if the player took only one guess, the award would be highest (e.g., $100). If the player took more than three guesses, the award would typically be lower (e.g., $10).

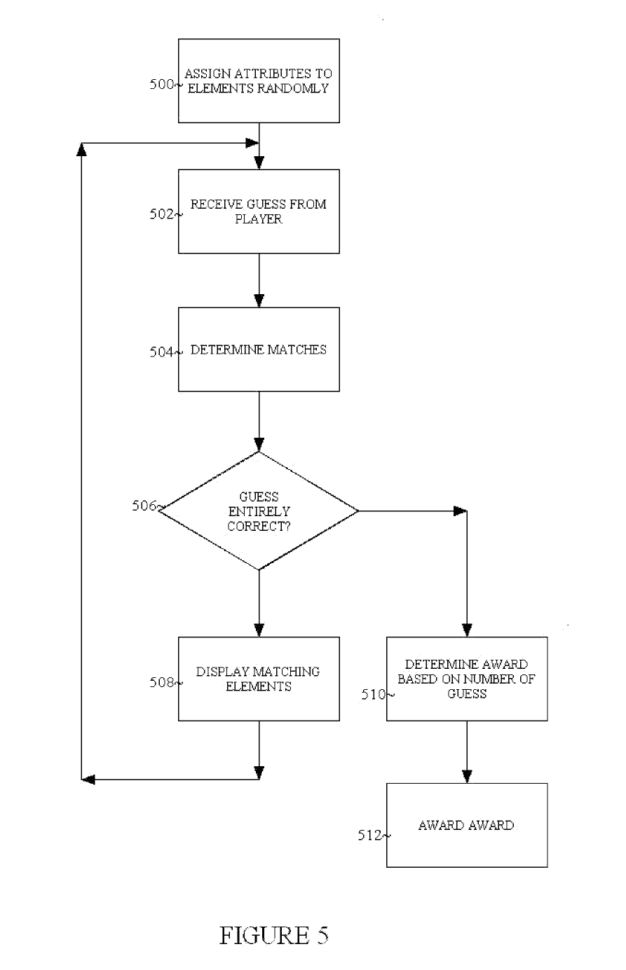

FIG. 5 is an exemplary flowchart of a method to implement a bonus round, according to an embodiment.

The method can begin with operation 500, which assigns attributes randomly to elements. For example, there can be ten (or any number) of boxes and ten (an equal number) of balls of different colors (with or without replacement, depending on the embodiment), and each ball can be assigned a particular box. The assignments are not displayed to the player, as it is the goal for the player to guess the assignments.

From operation 500, the method proceeds to operation 502, which receives a guess from the player. The player associates an attribute (color) with each element (box) by using a touch screen, mouse, keyboard, etc. Once all of the elements have been assigned a color by the player, the player can then prompt the machine to proceed to operation 504.

In operation 504, the computer (electronic gaming device) implementing the bonus round will determine which of the elements have a correct attribute (from the player's guess in operation 502). The correct guessed elements can be displayed to the player (now or at a later operation, such as operations 508 or 510).

From operation 504, the method can proceed to operation 506, which determines whether all of the elements have been guessed correctly (assigned to their respective attributes originally determined in operation 500). If the last player's guess isn't entirely correct (all of the elements were correctly assigned by the player to their respective original attributes), then the method can proceed to operation 508, which displays to the player which elements were correctly guessed. From operation 508, the method can then return to operation 502, which receives another guess from the player. The process can continue iteratively until the player's entire guess is correct.

In operation 506, if it is determined that the player's entire guess is correct (every element was properly assigned by the player to its respective original attribute from operation 500), then the method can proceed to operation 510, which determines an award based on the number of guesses the player took (the number of times operation 502 was performed). This can be determined using a paytable, such as illustrated in Table I.

From operation 510, the method can proceed to operation 512, which actually dispenses the award to the player (paying the player coins or credits, etc.) From either operation 508 or 512, the bonus round is now over. A brand new slot game can now be played.

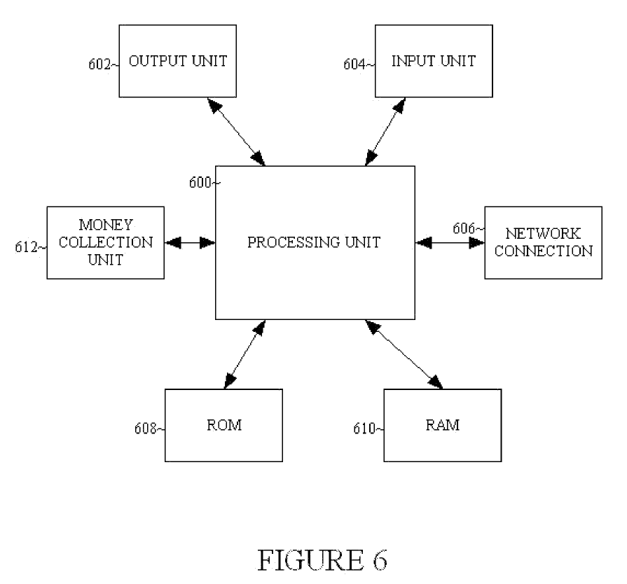

FIG. 6 is a block diagram of one example of hardware that can be used to implement the method, according to an embodiment.

A processing unit 600 (which can comprise a microprocessor and related components) can be connected to an output unit 602 (e.g., LCD or touch screen, etc.), an input unit 604 (e.g. a touch screen, keyboard, buttons, etc.), a network connection 606 (e.g. connection to a casino server or the Internet or other communication network), a ROM 608, a RAM 610, and any other hardware known in the art needed to implemented a digital version of the game (not pictured). The game can also be served to a remote client playing at an online casino over a computer communications network (such as the internet). A money collection unit 612 can be used to receive cash (e.g., a bill acceptor), or other payment from such as electronic payment and credit. A storage unit 614 can be a CD-ROM drive, a DVD-ROM drive, or any device that can read a computer readable storage medium. A CD-ROM 616 (or any other type of computer readable storage medium) can be read by the storage unit 614 and can contain data, assets, programs, etc., in order to implement the methods described herein on an electronic gaming machine such as the one illustrated in FIG. 6.

The methods described herein can be implemented on an electronic gaming device using a video output display, or alternatively can be implemented on a mechanical slot machine which uses physical reels. The user can manipulate the reels in order to make his or her guess as to which symbols comprise the player's guess. Thus, all of the methods described herein can be applied to a mechanical slot machine.

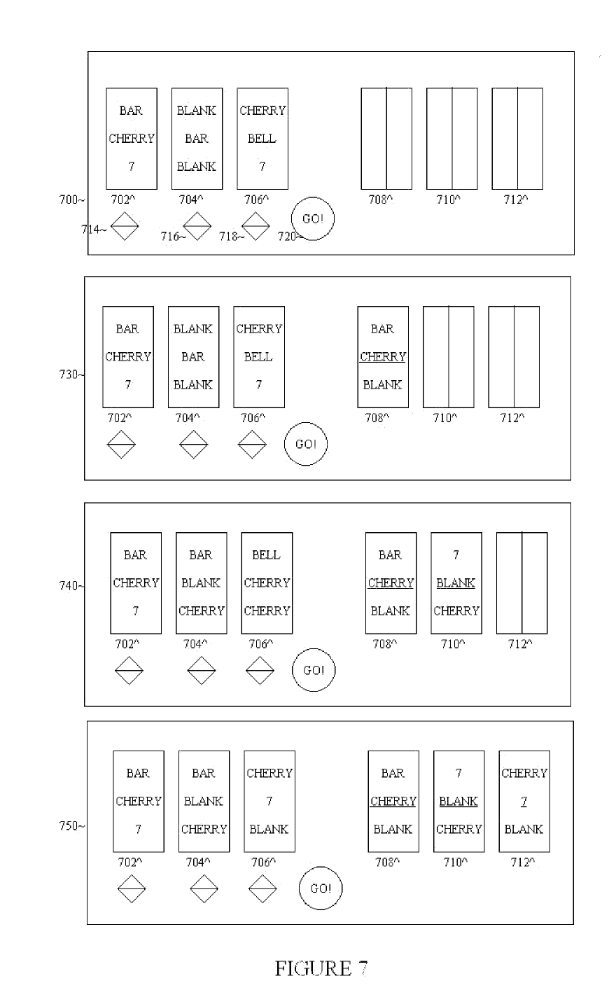

FIG. 7 is a drawing of a guessing game using mechanical slot reels, according to an embodiment.

First state slot machine 700 comprises parts of a mechanical slot machine in an initial state. A first reel 702, second reel 704, and third reel 706 each have a respective up/down button 714, 716, 718. The up/down buttons are used to turn each respective slot machine reel up or down. A go button 720 is pressed by the player when the player has finished selecting the symbols for each reel so that the machine can make the comparison.

The slot machine will select random symbols in the center of each of the second set of reels (comprising second set first reel 708, second set second reel 710, and second set third reel 712). These reels are hidden from view (e.g., by a mechanical door so that the player cannot see which symbols are behind each of the second set of reels).

The player uses the up/down buttons to adjust their respective reel to the center symbol that the player wishes to select. For example, the first up/down button 702 is used to control the first reel 702, the second up/down button 716 is used to control the second reel 704, and the third up/down button 718 is used to control the third reel 708. In the example illustrated in FIG. 7, the player has selected the cherry symbol for the first reel, the bar symbol for the second reel, and the bell symbol for the third reel. Thus, the player's guess at which symbols appear in the center on the second set of reels is: cherry/bar/bell. The player then presses the go button 720 in order to initiate to indicate the player is done guessing and hence initiates the machine to analyze the player's guess.

Second state slot machine 730 shows the first state slot machine 710 advanced into a further state after the player has made his or her guess and pressed the go button 720. It turns out that only the first reel 702 had the correct symbol, thus the second set first reel 708 opens to show the player that that reel has been guessed correctly. Thus, the first reel 702 corresponds to the second set first reel 708, while the second reel 704 corresponds to the second set second reel 710, while the third reel 706 corresponds to the second set third reel 712. Since the (center symbol) of the second set second reel 710 is not a bar, and the (center symbol) of the second set third reel 712 is not a bell, these reels were not guessed correctly by the player and remain closed.

The player now adjusts the second reel 704 and the third reel 706 (using the up/down buttons) in order to make another guess. Third state slot machine 740 is the second state slot machine 730 now in a subsequent third state. The player has changed the second reel 704 and the third reel 706 to different symbols in order to guess again. The player presses the go button, upon which the second set second reel 710 now opens to indicate that the player's guess using the second reel 704 is correct (since the second set second reel 710 center symbol matches the center symbol of the second reel 704). Thus, the player has now guessed two symbols correctly, and the third reel 706 is the only remaining symbol that the player has not yet guessed correctly.

Fourth state slot machine 750 is the third state slot machine 740 now in a subsequent fourth state. The player has adjusts the third reel 706 to select the ‘7’ symbol as the player's guess for the corresponding symbol in the second set third reel 712. After the player presses the go button, the machine analyzes the player's guess to determine all of the matches (between the first reel 702 and the corresponding second set first reel 708, the second reel 704 and the corresponding second set second reel 710, and the third reel 706 and the corresponding second set third reel 712). It turns out that the player has guessed correctly on the third reel 706, as all of the second set of reels now match the first set of reels (reel 702, reel 704, and reel 706), and the player has successfully completed the bonus round by guessing all of the symbols correctly.

Thus, in this example, the player took three guesses in order to guess the symbols correctly. As described herein, the number of guesses is used to determine the player's award.

It is noted that a mechanical slot machine can implement a guessing game in other configurations as well besides the one illustrated in FIG. 7. For example, the second reel set can be optional. Instead of using the second reel set, only one reel set can be used (the first reel set as illustrated in FIG. 7). If the player has guessed right in a reel in the first reel set, then a light (or other indicator) indicates a correct guess. Thus, the player would continue to manipulate reels that have incorrect guesses (symbols) and keep choosing symbols and guessing again until the player achieves an entirely correct guess (all reels were guessed with the proper symbols). Thus, this is similar as the embodiment described above (and illustrated in FIG. 7), but there is no second set of reels, and each reel in the first reel set will have an indicator indicating of that reel was guessed properly.

Further, the order of any of the operations described herein can be performed in any order and wagers can be placed/resolved in any order. Any operation described herein can also be optional. Any embodiments herein can also be played in electronic form and programs and/or data for such can be stored on any type of computer readable storage medium (e.g. CD-ROM, DVD, disk, etc.) The bonus round described herein can be played on an electronic gaming device or in association with a mechanical slot reel by attaching the electronics (including a touch screen) to the mechanical slot machine so that the bonus round can be implemented.

The descriptions provided herein also include any hardware and/or software known in the art and needed to implement the operations described herein. All components illustrated herein may also optionally communicate with any other illustrated or described component.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a bonus game, the method comprising:
displaying at least two first elements;
displaying at least two second elements, a number of second elements being equal to a number of first elements;
determining randomly at least two preselected associations between each of the first elements and the second elements; a number of preselected associations being equal to the number of first elements;
allowing a player to input at least two guessed associations;
identifying correctly guessed associations which comprise each of the guessed associations that matches preselected associations;
outputting to the player the correctly guessed associations;
permitting the player to continue the allowing, identifying, and outputting, until the identifying identifies that all guessed associations match all preselected associations, upon which the bonus round is completed; and
awarding an award based on a number of guesses required by the player until the bonus round is completed.

2. The method as recited in claim 1, wherein a lower number of guesses required by the player results in a higher award.

3. The method as recited in claim 1, wherein if the player guesses all associates correctly on a first guess the player wins a highest possible award.

4. The method as recited in claim 1, wherein the award is determined using a paytable based on the required number of guesses.

5. The method as recited in claim 1, wherein the award is determined using a formula from a paytable based on the required number of guesses.

6. The method as recited in claim 1, wherein the player is given a predetermined maximum number of guesses.

7. The method as recited in claim 1, further comprising offering the player to receive a hint comprising a particular attribute associated to a respective particular element in exchange for a reduced award for the bonus round.

8. An apparatus to play a bonus game, the apparatus comprising:
a processing unit to perform:
displaying at least two first elements;
displaying at least two second elements, a number of second elements being equal to a number of first elements;
determining randomly at least two preselected associations between each of the first elements and the second elements; a number of preselected associations being equal to the number of first elements;
allowing a player to input at least two guessed associations;
identifying correctly guessed associations which comprise each of the guessed associations that matches preselected associations;
outputting to the player the correctly guessed associations;
permitting the player to continue the allowing, identifying, and outputting, until the identifying identifies that all guessed associations match all preselected associations, upon which the bonus round is completed;
awarding an award based on a number of guesses required by the player until the bonus round is completed; and
an output device to output results of the processing unit.

9. The apparatus as recited in claim 8, wherein a lower number of guesses required by the player results in a higher award.

10. The apparatus as recited in claim 8, wherein if the player guesses all associates correctly on a first guess the player wins a highest possible award.

11. The apparatus as recited in claim 8, wherein the award is determined using a paytable based on the required number of guesses.

12. The apparatus as recited in claim 8, wherein the award is determined using a formula from a paytable based on the required number of guesses.

13. The apparatus as recited in claim 8, wherein the player is given a predetermined maximum number of guesses.

14. The apparatus as recited in claim 8, further comprising offering the player to receive a hint comprising a particular attribute associated to a respective particular element in exchange for a reduced award for the bonus round.

15. An apparatus to play a bonus game, the apparatus comprising:
displaying at least two mechanical slot reels, each reel comprising a plurality of symbols;
determining at least two random symbols for each reel, each random symbol corresponding to each of the at least two slot reels;
allowing a player to rotate each of the at least two mechanical slot reels to display a guessed symbol on each reel, the guessed symbol selected by the player;
identifying which guessed symbols match corresponding random symbols;
permitting the player to repeat the allowing and identifying until all guessed symbols match corresponding random symbols; and
awarding an award to the player based on a number of times the allowing is performed.

16. The apparatus as recited in claim 15, wherein a lower number of guesses required by the player results in a higher award.

17. The apparatus as recited in claim 15, wherein if the player guesses all associates correctly on a first guess the player wins a highest possible award.

18. The apparatus as recited in claim 15, wherein the award is determined using a paytable based on the required number of guesses.

19. The apparatus as recited in claim 15, wherein the award is determined using a formula from a paytable based on the required number of guesses.

20. The apparatus as recited in claim 15, wherein the player is given a predetermined maximum number of guesses.
